(19) United States
(12) Patent Application Publication
(10) Pub. No.: US 2025/0331670 A1
(43) Pub. Date: Oct. 30, 2025

(54) ELECTRIC DRILLING-FREE MOUNTING DEVICE FOR MOUNTING CURTAIN AND TOP BEAM MOUNTING ASSEMBLY THEREOF

(71) Applicant: NINGBO LIYANG NEW MATERIAL COMPANY LIMITED, Ningbo City (CN)

(72) Inventors: Baoguo TAN, Ningbo City (CN); Jianhong WEI, Ningbo City (CN)

(21) Appl. No.: 18/885,536

(22) Filed: Sep. 13, 2024

(30) Foreign Application Priority Data
Apr. 26, 2024 (CN) 202410515999.7

(51) Int. Cl. A47H 1/122; A47H 1/102

(52) U.S. Cl. CPC A47H 1/122; A47H 1/102

(57) ABSTRACT

The present disclosure discloses an electric drilling-free mounting device for mounting a curtain and a top beam mounting assembly thereof, which comprises a housing, with a chamber disposed inside and an end cover connected at one end. A power component, a pressing assembly and an elastic adjusting assembly are sequentially mounted inside the chamber. The power component is fixedly disposed, and a power output end of the power component is in transmission connection with the pressing assembly. One end of the elastic adjusting assembly is abutted against the pressing assembly and the other end abutted against the end cover; the end abutted against the end cover is partially penetrated through the end cover and exposed outside the housing for pre-positioning. The elastic adjusting assembly has an elastic telescoping travel, and the power component drives the pressing assembly to press or release the elastic adjusting assembly.

This application is based upon and claims priority to Chinese Patent Application No. 202410515999.7, filed on Apr. 26, 2024, the entire contents of which are incorporated herein by reference.

### TECHNICAL FIELD

The present disclosure relates to the field of curtain technologies and in particular to an electric drilling-free mounting device for mounting a curtain and a top beam mounting assembly thereof.

### BACKGROUND

The curtains are widely applied in the locations such as homes and offices to adjust indoor light. The curtains commonly used nowadays comprise roller blinds, venetian blinds and honeycomb blinds. Generally, these curtains are fixedly mounted on window frames by mounting brackets and screws. Since it is required to open screw holes on the window frames for mounting the curtains, when remounting or change of the curtains is required, new screw holes are to be opened without using the original ones, which will inevitably leave many screw holes on the walls of the window frames, damaging the walls and affecting the aesthetics. Further, drilling and mounting will consume much time and labor and also produce dusts which are difficult to clean. Although there appear many mountable-without-drilling curtains on the markets, the existing drilling-free mounting components are to be operated manually during use, and are basically supported on the window frames by elastic assembling, and then locked and limited by manual adjustment. Because the mounting positions of the curtains mostly have a given mounting height, people need to climb to the mounting height for manual mounting and adjustment. Therefore, the manual operation is time-consuming, labor-consuming and troublesome.

### SUMMARY

In order to solve the above technical problems in the prior arts, the present disclosure provides an electric drilling-free mounting device for mounting a curtain and a top beam mounting assembly thereof, so as to electrically control the curtain to be mounted without drilling, realizing simple and quick mounting and saving time and labor.

In order to solve the above technical problems, the present disclosure employs the following technical solution: there is provided an electric drilling-free mounting device for mounting a curtain, which comprises a housing. An end of the housing is connected with an end cover and a chamber is disposed inside the housing. A power component, a pressing assembly and an elastic adjusting assembly are sequentially mounted inside the chamber in a direction from an end away from the end cover to the end cover. The power component is fixedly disposed inside the chamber, and a power output end of the power component is in transmission connection with the pressing assembly. One end of the elastic adjusting assembly is abutted against the pressing assembly and the other end is abutted against the end cover. The end of the elastic adjusting assembly abutted against the end cover is partially penetrated through the end cover and exposed outside the housing for pre-positioning. The elastic adjusting assembly has an elastic telescoping travel, and the power component drives the pressing assembly to press or release the elastic adjusting assembly.

Furthermore, the pressing assembly comprises a screw rod and a slide block in thread connection with the screw rod. An end of the screw rod away from the slide block is in transmission connection with the power output end of the power component and an end of the slide block away from the screw rod is abutted against the elastic adjusting assembly. The slide block makes reciprocating rectilinear movement along a length direction of the screw rod under the action of the rotation of the screw rod to press or release the elastic adjusting assembly.

Furthermore, the elastic adjusting assembly comprises an ejection rod, a first spring and a second spring, where the first spring and the second spring are sleeved on the ejection rod. A baffle sheet is disposed between the first spring and the second spring, and an annular protrusion is disposed on the ejection rod. In a natural state, one end of the first spring is abutted against the annular protrusion and the other end is abutted against the baffle sheet; one end of the second spring is abutted against the baffle sheet and the other end is abutted against the slide block. The annular protrusion is abutted against the end cover. A part of the ejection rod is penetrated through the end cover and exposed outside the housing for pre-positioning.

Furthermore, the second spring has a larger elastic force than the first spring.

Furthermore, a central hole for avoiding the ejection rod is disposed in the slide block, and a central channel for avoiding the ejection rod is disposed in the screw rod.

Furthermore, an external thread is disposed on the screw rod and an internal thread matching the external thread is disposed on the slide block.

Furthermore, the power component is a motor.

Furthermore, a circuit board is disposed inside the housing. The motor is electrically connected with the circuit board. A current sensor is disposed on the circuit board. When the current sensor senses that a working current of the motor is greater than a set value, the circuit board controls the motor to stop working.

There is provided a top beam mounting assembly, which comprises a top beam and the above electric drilling-free mounting device. The electric drilling-free mounting device is mounted at an end of the top beam. Both ends of the top beam are connected respectively with a first sealing cover and a second sealing cover. The first sealing cover is fixedly connected with the electric drilling-free mounting device. An ejection block is disposed on the first sealing cover. The ejection block is connected with the elastic adjusting assembly exposed outside the housing to abut against the mounting wall surface so as to achieve pre-positioning.

Furthermore, a mounting chamber in which the ejection block makes rectilinear slide is disposed in the first sealing cover and a through hole for the elastic adjusting assembly exposed outside housing to run through is opened in the mounting chamber.

Compared with the prior arts, the present disclosure has the following advantages: in the present disclosure, the pre-positioning mounting is achieved by the elastic telescoping travel of the elastic adjusting assembly, and then the power component electrically controls the pressing assembly to press the elastic adjusting assembly so as to complete the fixed mounting. During dismounting process, the power component electrically controls the pressing assembly to release the elastic adjusting assembly such that the elastic adjusting assembly can elastically extend or retract for an adjusting length, so as to dismount the curtain. In this process, the locking and unlocking can be electrically achieved by the power component, without human operations, bringing use conveniences and saving time and labor.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a structural schematic diagram of the present disclosure.

FIG. 2 is a structural schematic diagram illustrating a disassembled housing according to the present disclosure.

FIG. 3 is an exploded view of the present disclosure.

FIG. 4 is a front sectional view of the present disclosure.

FIG. 5 is a structural schematic diagram illustrating a slide block according to the present disclosure.

FIG. 6 is a structural schematic diagram illustrating a top beam mounting assembly according to the present disclosure.

FIG. 7 is a schematic diagram illustrating a first sealing cover dismounted from the top beam mounting assembly according to the present disclosure.

FIG. 8 is a structural schematic diagram illustrating the first sealing cover of the top beam mounting assembly according to the present disclosure.

Numerals of the drawings are described below: 1. housing. 1.1 chamber, 2. end cover, 3. power component, 4. screw rod, 4.1 central channel, 4.2 external thread, 5. slide block, 5.1 central hole, 5.2 internal thread, 6. ejection rod, 6.1 annular protrusion, 7. first spring, 8. second spring, 9. baffle sheet, 10. circuit board, 11. current sensor, 12. top beam, 13. first sealing cover, 13.1 mounting chamber, 13.2 through hole, 14. second sealing cover, and 15. ejection block.

### DETAILED DESCRIPTIONS OF EMBODIMENTS

The present invention will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

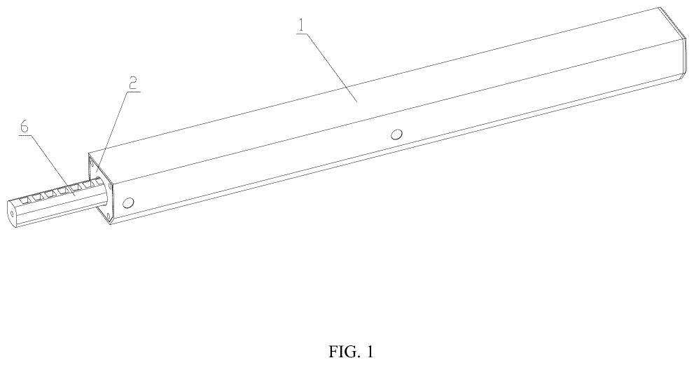

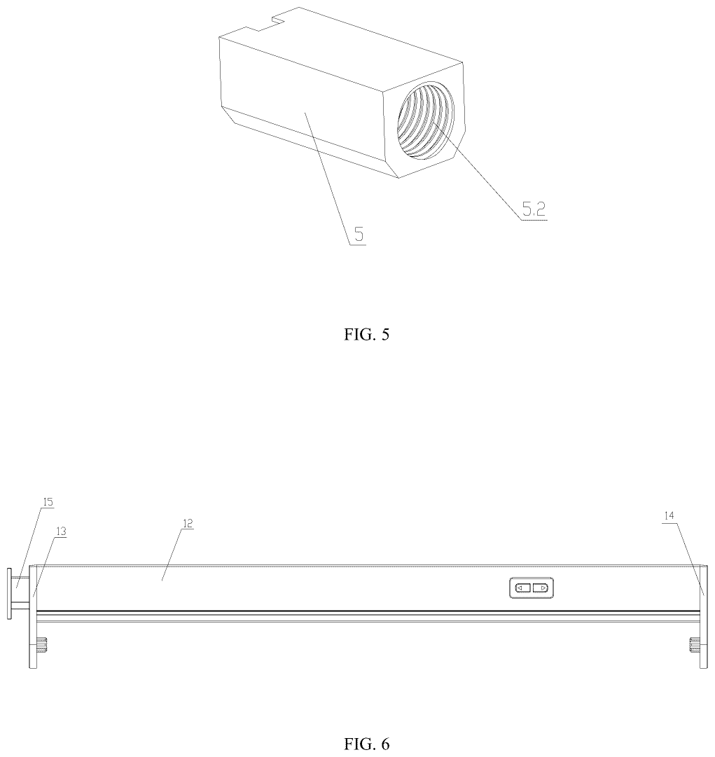

As shown in FIGS. 1 to 5, the present disclosure provides an electric drilling-free mounting device for mounting a curtain, which comprises a housing 1. An end of the housing 1 is connected with an end cover 2 and a chamber 1.1 is disposed inside the housing 1. A power component 3, a pressing assembly and an elastic adjusting assembly are sequentially mounted inside the chamber 1.1 in a direction from an end away from the end cover 2 to the end cover 2. The power component 3 is fixedly disposed inside the chamber 1.1, and a power output end of the power component 3 is in transmission connection with the pressing assembly. One end of the elastic adjusting assembly is abutted against the pressing assembly and the other end is abutted against the end cover 2. The end of the elastic adjusting assembly abutted against the end cover 2 is partially penetrated through the end cover 2 and exposed outside the housing 1 for pre-positioning. The elastic adjusting assembly has an elastic telescoping travel, and the power component 3 drives the pressing assembly to press or release the elastic adjusting assembly.

In the present disclosure, the pre-positioning mounting is achieved by the elastic telescoping travel of the elastic adjusting assembly, and then the power component 3 electrically controls the pressing assembly to press the elastic adjusting assembly so as to complete the fixed mounting. During dismounting process, the power component 3 electrically controls the pressing assembly to release the elastic adjusting assembly such that the elastic adjusting assembly can elastically extend or retract for an adjusting length, so as to dismount the curtain. In this process, the locking and unlocking can be electrically achieved by the power component 3, without human operations, bringing use conveniences and saving time and labor.

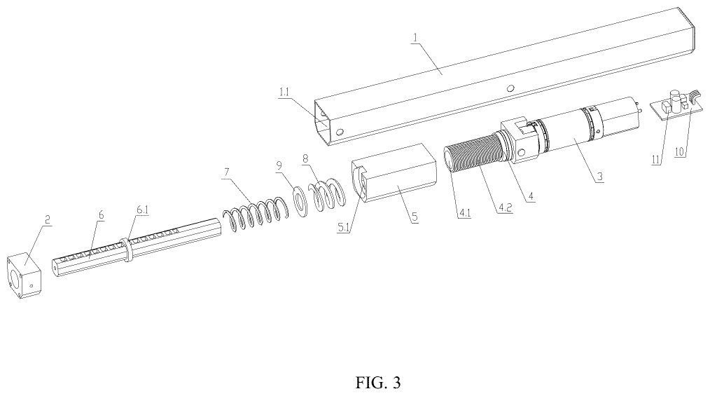

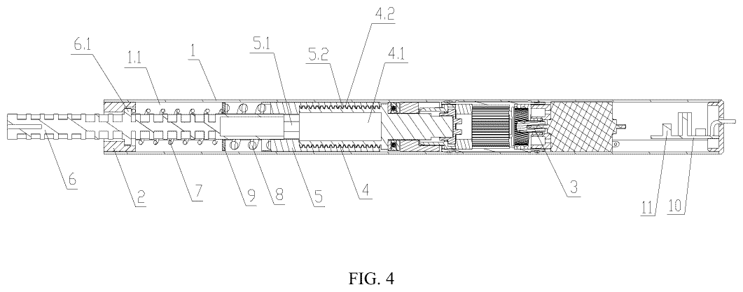

As shown in FIGS. 3 and 4, the pressing assembly comprises a screw rod 4 and a slide block 5 in thread connection with the screw rod 4. An end of the screw rod 4 away from the slide block 5 is in transmission connection with the power output end of the power component 3 and an end of the slide block 5 away from the screw rod 4 is abutted against the elastic adjusting assembly. The slide block 5 makes reciprocating rectilinear movement along a length direction of the screw rod 4 under the action of the rotation of the screw rod 4 to press or release the elastic adjusting assembly. For example, when the power component 3 drives the screw rod 4 to rotate clockwise, the slide block 5 on the screw rod 4 is moved toward the elastic adjusting assembly along threads so as to compress the elastic telescoping travel of the elastic adjusting assembly, achieving the locking effect. In this way, the pre-positioning mounting can be further locked and fixed without manual locking, simplifying the operations. When the power component 3 drives the screw rod 4 to rotate counterclockwise, the slide block 5 on the screw rod 4 is moved toward the power component 3 along the threads so as to release the elastic telescoping travel of the elastic adjusting assembly, achieving the unlocking effect. Thus, the elastic adjusting assembly can be adjusted within a length range, facilitating the dismounting.

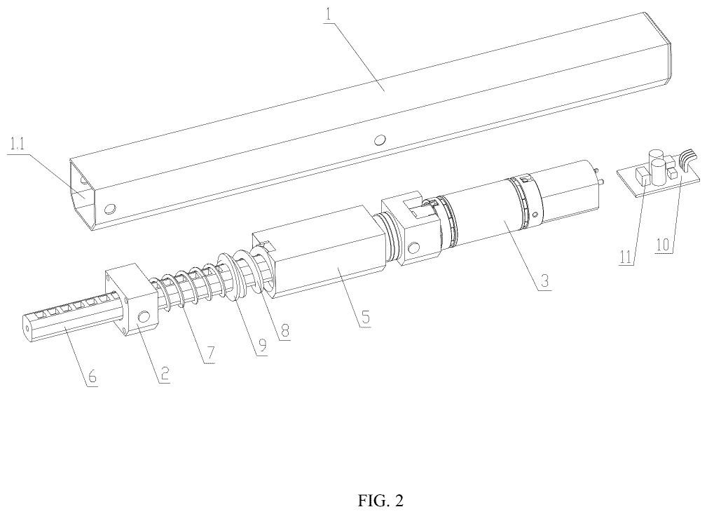

With reference to FIGS. 2, 3 and 4, the elastic adjusting assembly comprises an ejection rod 6, a first spring 7 and a second spring 8, where the first spring 7 and the second spring 8 are sleeved on the ejection rod 6. A baffle sheet 9 is disposed between the first spring 7 and the second spring 8, and an annular protrusion 6.1 is disposed on the ejection rod 6. In a natural state, one end of the first spring 7 is abutted against the annular protrusion 6.1 and the other end is abutted against the baffle sheet 9; one end of the second spring 8 is abutted against the baffle sheet 9 and the other end is abutted against the slide block 5. The annular protrusion 6.1 is abutted against the end cover 2 to achieve axial limitation. A part of the ejection rod 6 is penetrated through the end cover 2 and exposed outside the housing 1 for pre-positioning. For example, the ejection rod 6 exposed outside the housing 1 is abutted against a mounting wall surface, and a length that the ejection rod 6 protrudes out of the housing 1 can be adjusted by the elastic extension and retraction of the first spring 7 and the second spring 8 so as to achieve the pre-positioning mounting. Then, the screw rod 4 is driven by the power component 3 to push the slide block 5 to squeeze or release the first spring 7 and the second spring 8, achieving the locking and unlocking.

The second spring 8 has a larger elastic force than the first spring 7. The first spring 7 is slenderer and the second spring 8 is stubbier. Since the first spring 7 has a smaller elastic force, the range of the elastic adjusting length is larger. The adjusting length is mainly applied to the telescoping length of the ejection rod 6 for pre-positioning mounting. Since the second spring 8 has a larger elastic force and the range of the elastic adjusting length is smaller. The adjusting length can be used to achieve length compensation when deformation occurs over long time of use after fixed mounting, so as to avoid falling off due to long time of use. For example, if one spring is used alone, when the spring has an excessively small elastic force, although pre-positioning mounting can be achieved by adjusting the telescoping length of the ejection rod 6 easily, the spring may lose its elasticity over a long time of use and hence the curtain may easily fall off. When the spring has an excessively large elastic force, the telescoping length of the ejection rod 6 is adjusted with more effort, but the spring can serve for a longer life without causing the curtain to easily fall off. Therefore, the combined use of the first spring 7 and the second spring 8 can not only facilitate achieving pre-positioning mounting by adjusting the telescoping length of the ejection rod 6 but also prevent the falling-off of the curtain resulting from long time of use, ensuring longer and safer service life.

With reference to FIGS. 3 to 5, a central hole 5.1 for avoiding the ejection rod 6 is disposed in the slide block 5, and a central channel 4.1 for avoiding the ejection rod 6 is disposed in the screw rod 4. When the ejection rod 6 makes reciprocating movement along its length direction, the central hole 5.1 and the central channel 4.1 are provided for the ejection rod 6 to perform obstacle-free movement. An external thread 4.2 is disposed on the screw rod 4 and an internal thread 5.2 matching the external thread 4.2 is disposed on the slide block 5. The slide block 5 performs reciprocating rectilinear movement along the length direction of the screw rod 4 through cooperation of the internal thread 5.2 and the external thread 4.2.

With reference to FIGS. 2 to 4, the power component 3 is a motor which comprises a motor core and a speed reducer. The motor provides power for the rotation of the screw rod 4. A circuit board 10 is disposed inside the housing 1. The motor is electrically connected with the circuit board 10. A current sensor 11 is disposed on the circuit board 10. When the current sensor 11 senses that a working current of the motor is greater than a set value, the circuit board 10 controls the motor to stop working. The disposal of the current sensor 11 enables the motor to provide a controlled locking force. When the first spring 7 and the second spring 8 are compressed tighter, a larger elastic force can be generated and meanwhile the motor needs a larger working current. Therefore, by sensing the working current of the motor by using the current sensor 11, the motor can be controlled to provide a controlled locking force, without excessively driving the screw rod 4 to push the slide block 5 to squeeze the first spring 7 and the second spring 8.

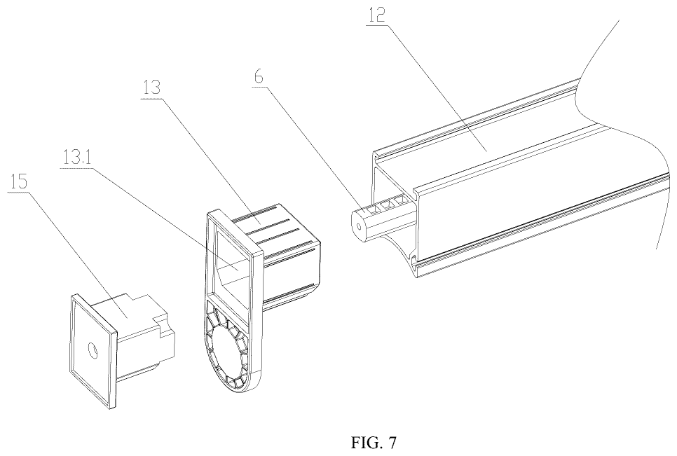

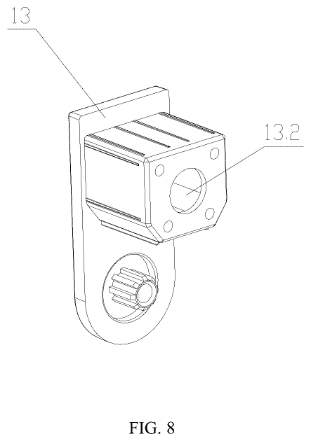

As shown in FIGS. 6 to 8, there is provided a top beam mounting assembly, which comprises a top beam 12 and the above electric drilling-free mounting device. The electric drilling-free mounting device is mounted at an end of the top beam 12. Both ends of the top beam 12 are connected respectively with a first sealing cover 13 and a second sealing cover 14. The second sealing cover 14 is defined to comprise not only an ordinary part for blocking the end of the top beam 12 but also a part connected with the end of the top beam 12 to achieve blocking effect on the end of the top beam 12, for example, an end part of a drive device, a transmission device, or a power supply device or the like. The first sealing cover 13 is fixedly connected with the electric drilling-free mounting device, and preferably, the first sealing cover 13 is detachably connected with the end cover 2. An ejection block 15 is slidably disposed on the first sealing cover 13. The ejection block 15 is connected with the elastic adjusting assembly exposed outside the housing 1 to abut against the mounting wall surface so as to achieve pre-positioning, and preferably, the ejection block 15 is connected with an end of the ejection rod 6 exposed outside the housing 1 to increase an abutting contact area with the mounting wall surface. A mounting chamber 13.1 in which the ejection block 15 makes rectilinear slide is disposed in the first sealing cover 13. A through hole 13.2 for the elastic adjusting assembly exposed outside housing 1 to run through is opened in the mounting chamber 13.1, and preferably, the through hole 13.2 is provided for the ejection rod 6 exposed outside the housing 1 to run through. The structural disposal helps change the first sealing cover 13, the second sealing cover 14 and the ejection block 15 such that the electric drilling-free mounting device can adapt to different types of top beams 12, leading to more flexible assembling and wider application scope. Moreover, quick electric drilling-free mounting of the curtain can be achieved, saving time and labor.

During use, the electric drilling-free mounting device is connected with the first sealing cover 13 and the ejection block 15, and then inserted to the other end of the top beam 12 and then connected with the second sealing cover 14 at the other end of the top beam 12. A curtain body may be assembled below the top beam 12. Firstly, the end of the top beam 12 having the ejection block 15 is abutted against the mounting wall surface, and then the other end of the top beam 12 is abutted against an opposite mounting wall surface; by using an elastic force of the first spring 7 and the second spring 8 for squeezing the ejection rod 6 outwardly, the top beam 12 is pre-positioned and mounted on a window frame; then the motor works to rotate the screw rod 4 and hence the slide block 5 is slid toward the second spring 8 along the screw rod 4 so as to squeeze the first spring 7 and the second spring 8 until the current sensor 11 senses that the working current of the motor reaches a preset value. At this time, the circuit board 10 controls the motor to stop working so as to achieve compression on the first spring 7 and the second spring 8, locking the ejection rod 6. In this case, the top beam 12 is fixedly mounted on the window frame. The motor can provide a controlled locking force based on the preset working current value. Therefore, electric operation can be carried out with less time and labor. During practical use, the elastic force of the second spring 8 can achieve length compensation when deformation occurs due to long time of use after fixed mounting. In this way, the curtain is prevented from falling off after long time of use. Furthermore, during dismounting process, the motor rotates reversely to push the screw rod 4 to rotate and thus the slide block 5 is slid away from the second spring 8 along the screw rod 4 so as to release the first spring 7 and the second spring 8, unlocking the ejection rod 6. At this time, the ejection rod 6 has an adjustable length range such that the top beam 12 can be dismounted from the window frame. When locking and unlocking are performed on the ejection rod 6, the slide block 5 is electrically driven by the motor to perform reciprocating movement without human operations, bringing use conveniences and saving time and labor.

The materials, reagents and experimental instruments involved in the embodiments of the present disclosure are all commercially-available products in the curtain field, unless otherwise stated.

Finally, it is to be pointed out that the above embodiments are merely used to describe the technical solution of the present disclosure rather than limit the present disclosure. Although detailed descriptions are made to the present disclosure by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present disclosure.

1. An electric drilling-free mounting device for mounting a curtain, wherein the device comprises a housing (1); an end of the housing (1) is connected with an end cover (2) and a chamber (1.1) is disposed inside the housing (1); a power component (3), a pressing assembly and an elastic adjusting assembly are sequentially mounted inside the chamber (1.1) in a direction from an end away from the end cover (2) to the end cover (2); the power component (3) is fixedly disposed inside the chamber (1.1), and a power output end of the power component (3) is in transmission connection with the pressing assembly; one end of the elastic adjusting assembly is abutted against the pressing assembly and the other end is abutted against the end cover (2); the end of the elastic adjusting assembly abutted against the end cover (2) is partially penetrated through the end cover (2) and exposed outside the housing (1) for pre-positioning; the elastic adjusting assembly has an elastic telescoping travel, and the power component (3) drives the pressing assembly to press or release the elastic adjusting assembly.

2. The electric drilling-free mounting device for mounting a curtain of claim 1, wherein the pressing assembly comprises a screw rod (4) and a slide block (5) in thread connection with the screw rod (4); an end of the screw rod (4) away from the slide block (5) is in transmission connection with the power output end of the power component (3) and an end of the slide block (5) away from the screw rod (4) is abutted against the elastic adjusting assembly; the slide block (5) makes reciprocating rectilinear movement along a length direction of the screw rod (4) under the action of the rotation of the screw rod (4) to press or release the elastic adjusting assembly.

3. The electric drilling-free mounting device for mounting a curtain of claim 2, wherein the elastic adjusting assembly comprises an ejection rod (6), a first spring (7) and a second spring (8); the first spring (7) and the second spring (8) are sleeved on the ejection rod (6); a baffle sheet (9) is disposed between the first spring (7) and the second spring (8), and an annular protrusion (6.1) is disposed on the ejection rod (6); in a natural state, one end of the first spring (7) is abutted against the annular protrusion (6.1) and the other end is abutted against the baffle sheet (9); one end of the second spring (8) is abutted against the baffle sheet (9) and the other end is abutted against the slide block (5); the annular protrusion (6.1) is abutted against the end cover (2); a part of the ejection rod (6) is penetrated through the end cover (2) and exposed outside the housing (1) for pre-positioning.

4. The electric drilling-free mounting device for mounting a curtain of claim 3, wherein the second spring (8) has a larger elastic force than the first spring (7).

5. The electric drilling-free mounting device for mounting a curtain of claim 3, wherein a central hole (5.1) for avoiding the ejection rod (6) is disposed in the slide block (5), and a central channel (4.1) for avoiding the ejection rod (6) is disposed in the screw rod (4).

6. The electric drilling-free mounting device for mounting a curtain of claim 2, wherein an external thread (4.2) is disposed on the screw rod (4) and an internal thread (5.2) matching the external thread (4.2) is disposed on the slide block (5).

7. The electric drilling-free mounting device for mounting a curtain of claim 1, wherein the power component (3) is a motor.

8. The electric drilling-free mounting device for mounting a curtain of claim 7, wherein a circuit board (10) is disposed inside the housing (1); the motor is electrically connected with the circuit board (10); a current sensor (11) is disposed on the circuit board (10); when the current sensor (11) senses that a working current of the motor is greater than a set value, the circuit board (10) controls the motor to stop working.

9. A top beam mounting assembly, wherein it comprises a top beam (12) and the electric drilling-free mounting device of claim 1; the electric drilling-free mounting device is mounted at an end of the top beam (12); both ends of the top beam (12) are connected respectively with a first sealing cover (13) and a second sealing cover (14); the first sealing cover (13) is fixedly connected with the electric drilling-free mounting device; an ejection block (15) is disposed on the first sealing cover (13); the ejection block (15) is connected with the elastic adjusting assembly exposed outside the housing (1) to abut against the mounting wall surface so as to achieve pre-positioning.

10. The top beam mounting assembly of claim 9, wherein a mounting chamber (13.1) in which the ejection block (15) makes rectilinear slide is disposed in the first sealing cover (13) and a through hole (13.2) for the elastic adjusting assembly exposed outside housing (1) to run through is opened in the mounting chamber (13.1).
